(19) United States
(12) Patent Application Publication
(10) Pub. No.: US 2026/0054277 A1
(43) Pub. Date: Feb. 26, 2026

(54) HANDSHOWER WITH A SPRAYER FUNCTION

(71) Applicant: Xiamen Rainshower Co. Ltd., XIAMEN (CN)

(72) Inventors: Hewei LIU, XIAMEN (CN); Ruiqiang ZHANG, XIAMEN (CN)

(21) Appl. No.: 19/293,112

(22) Filed: Aug. 7, 2025

(30) Foreign Application Priority Data
Aug. 20, 2024 (CN) 2024111471558

(51) Int. Cl. B05B 1/18; B05B 1/16

(52) U.S. Cl. CPC B05B 1/1896; B05B 1/169; B05B 1/1825; B05B 1/189

(57) ABSTRACT

A handshower with a sprayer function, includes a head portion and a handle portion, wherein the head portion comprises a showerhead housing, a water distribution body, a turning tray, a spray outlet assembly, a shower outlet assembly and a switching handle; the showerhead housing is provided with a spray outlet assembly at one end away from the handle portion, and the spray outlet assembly includes at least one spray nozzle. The water distribution body is composed of a water outlet tray and a water distribution tray arranged side by side, the water outlet tray includes separated flow passage and at least one pressurizing chamber, the flow passage is in fluid communication with the shower outlet assembly, the pressurizing chamber is in fluid communication with the spray outlet assembly, the turning tray is turnably provided on the water distribution tray.

### CROSS REFERENCE TO RELATED APPLICATIONS

This application is based upon and claims priority to Chinese Patent Application No. 202411147155.8, filed on August 20,2024, the entire contents of which are incorporated herein by reference.

### FIELD

This application relates to the field of bathroom, and in particular to a handshower with a sprayer function.

### BACKGROUND

US Patent US20220184643A discloses a showerhead 100 that can achieve a sprayer function and a shower function, which drives the outlet 512 of the flow director 208 to selectively fluidly communicate with the inlets 502a, 502b and 502c set in the vertical wall of the distribution chamber 500 by toggling the flow selector 116, so as to selectively guide the water flow through one of (a) the nozzles a, (b) a pair of first nozzles b and/or (c) the second nozzle c; through this structure, the water flows through the outlet 512 of the flow director 208 along the first direction A to the distribution chamber 500, and the back pressure generated is opposite to the first direction A, and the water flowing into the flow director 208 basically flows out from the outlet 512 at the first time, and cannot stay in the flow director 208 for a long enough time to generate a certain water pressure for pushing the sealing element 510, so it is necessary to set a sufficiently large pre-tightening force for the sealing element 510 on the flow director 208 to make it tightly attached to the vertical wall of the distribution chamber 500, so as to ensure that when the flow director 208 is swinging or being displaced, the water flowing into the flow director 208 will not overflow from the periphery of the sealing element 510, resulting in a heavy hand feel when the flow selector 116 is switched. Moreover, since the size of the mainstream showerhead 100 on the market is generally five to six inches, the space of the vertical wall of its distribution chamber 500 is very limited, so the aperture sizes of the inlets 502a, 502b and 502c are very limited, resulting in limited flow, so each nozzle a, b, c of the showerhead 100 needs to be equipped with a pressurizing chamber, otherwise the pressure of water sprayed outward is too low to meet the use requirements.

### SUMMARY

In view of the problems in the background, the object of the present invention is to provide a multifunctional handshower that can realize the sprayer function or the shower function, and its hand feel in switching is light.

In order to achieve the above object, the present application proposes a handshower with a sprayer function, comprising a head portion and a handle portion, wherein the head portion comprises a showerhead housing, a water distribution body, a turning tray, a spray outlet assembly, a shower outlet assembly and a switching handle;
the showerhead housing has a hollow inner cavity, and has a front end equipped with the spray outlet assembly and a rear end equipped with the switching handle, the spray outlet assembly comprises at least one spray nozzle, each of the at least one spray nozzle corresponds to a spray mode, and the shower outlet assembly is installed on the showerhead housing;
the water distribution body is arranged between the showerhead housing and the shower outlet assembly, and the water distribution body is composed of a water outlet tray and a water distribution tray arranged side by side in the front and back respectively, the water outlet tray comprises one flow passage and at least one pressurizing chamber, a water path of each of the at least one pressurizing chamber and a water path of the flow passage are separated from each other;
the water distribution tray comprises one first water distribution port and at least one second water distribution port, a number of the at least one pressurizing chamber and a number of the at least one second water distribution port are each consistent with a number of the at least one spray nozzle; a water outlet end of the first water distribution port of the water distribution tray forms one first water distribution channel, and an extension direction of the first water distribution channel is arranged crosswise with an opening direction of the first water distribution port, the first water distribution channel is in communication with the flow passage, and the flow passage is in communication with the shower outlet assembly; and a water outlet end of the at least one second water distribution port of the water distribution tray respectively form corresponding number of at least one second water distribution channel, an extension direction of each of the at least one second water distribution channel is arranged crosswise with an opening direction of the corresponding second water distribution port, each of the at least one second water distribution channel is in communication with the corresponding pressurizing chamber, and the pressurizing chamber is configured to pressurize the water flowing in and then come into communication with the corresponding spray nozzle;
the turning tray is turnably provided on the water distribution tray, a bottom end face of the turning tray is provided with a first water outlet in fluid communication with the handle portion, a sealing element is sleeved on the first water outlet, the sealing element is provided with a through hole corresponding to the first water outlet, a connecting member is provided at a central portion of the turning tray, and the showerhead housing is provided with a through hole at a position corresponding to the connecting member, the switching handle is fixedly connected to the connecting member through the through hole; and
when the switching handle is driven to turn, to further drive the first water outlet of the turning tray to come into fluid communication with the first water distribution port or one of the at least one second water distribution port, and in this way, water path switching of the spray outlet assembly and the shower outlet assembly is achieved.

Compared with the prior art, the present invention realizes the water path switching between the shower outlet assembly and the spray outlet assembly by rotating the switching handle arranged on the showerhead housing, thereby driving the first water outlet of the turning tray to connect to the first water distribution port or the second water distribution port of the water distribution tray of the water distribution body. Since the first water outlet of the turning tray and the first water distribution port or the second water distribution port of the water distribution tray are arranged from top to bottom (with the head portion being horizontally placed as a reference system), and since the first water distribution channel and the second water distribution channel are arranged at the water outlet ends of the first water distribution port and the second water distribution port in a manner intersecting with their water outlet direction, so that the turning tray forms a water storage cavity with a relatively low flow rate within the area of the first water outlet corresponding to the first water distribution channel or the second water distribution channel, and the sealing element located in the water storage cavity can be more closely attached to the water inlet end face of the water distribution tray under the action of water pressure, and also the back pressure formed by the turning tray at the first water outlet is reduced, so that the handshower does not need to be set at the factory to closely attach the sealing element at the first water outlet of the turning tray to the water inlet end face of the water distribution tray, which allows the turning tray to be easily turned relative to the water distribution tray. Moreover, the force application point of the switching handle is far away from the central axis of the turning tray. with the effect of amplification by the force arm, a small force can be applied to the free end of the switching handle to achieve the turning of the switching handle, thereby achieving the water path switching of the handshower. Moreover, since the water distribution tray is independently designed, it has enough space to configure the first water distribution port and the second water distribution port with larger apertures. Therefore, even if the shower outlet assembly is not equipped with a pressurizing chamber, but only with a flow passage, the shower outlet assembly can still spray out water with a sufficiently large water pressure to meet the shower needs.

### BRIEF DESCRIPTION OF THE DRAWINGS

FIG. 1 is a schematic perspective view of the present invention;

FIGS. 2 and 3 are schematic perspective exploded view of an embodiment of the present invention;

FIG. 4 is a schematic exploded view of a turning tray of the present invention;

FIG. 5 is a schematic diagram of a turning tray cover of the present invention;

FIGS. 6 and 7 are schematic diagrams of a water distribution body of an embodiment of the present invention;

FIG. 8 is a schematic diagram of a water inlet module of an embodiment of the present invention; and

FIGS. 9 to 13 are schematic diagrams of different water outlet states of an embodiment of the present invention.

### DETAILED DESCRIPTION OF EMBODIMENTS

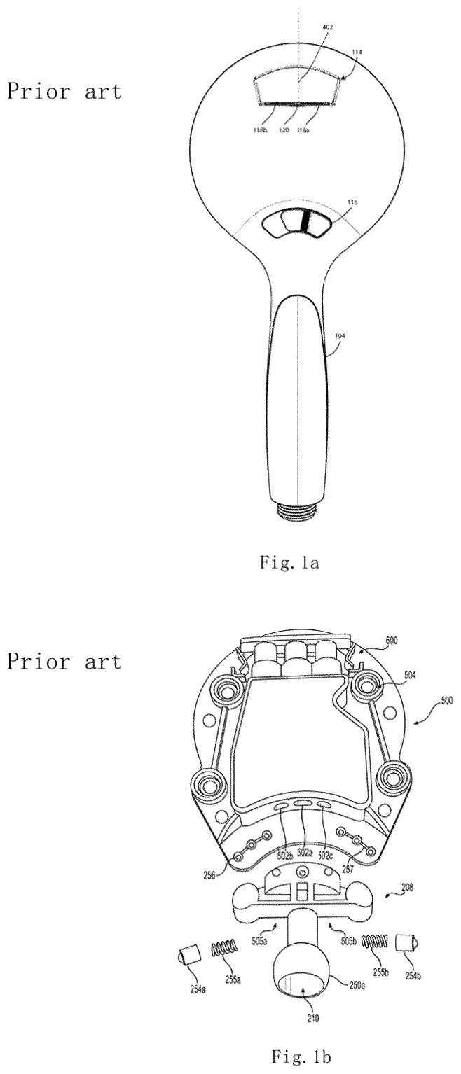

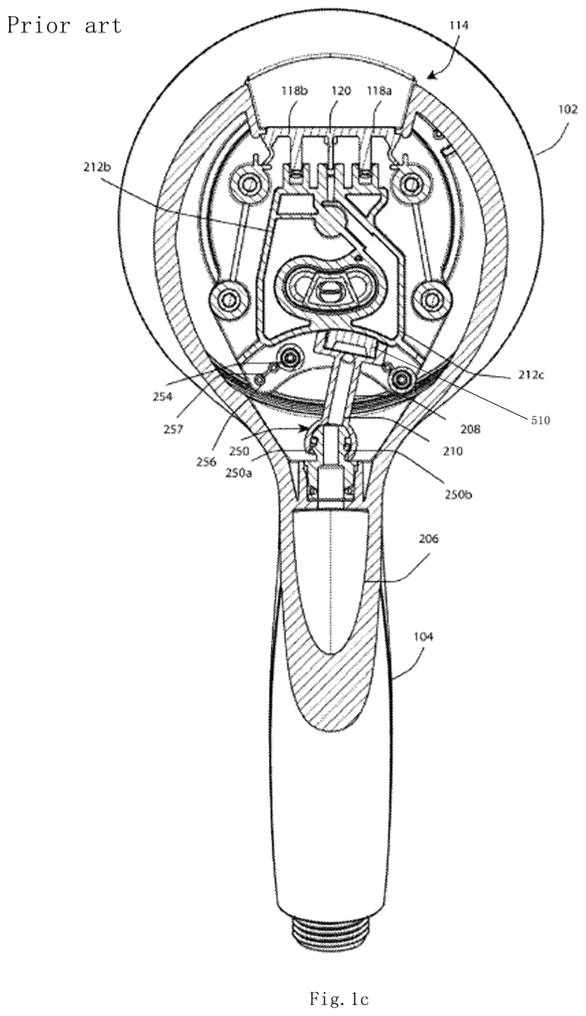

As shown in FIGS. 1 to 3, a handshower 100 with a sprayer function includes a head portion 101 and a handle portion 102. The head portion 101 includes a showerhead housing 2, a water inlet module 3, a water distribution body 4, a shower outlet assembly 7, a spray outlet assembly 21 and a switching handle 8. The showerhead housing 2 has a hollow inner cavity, and has a front end equipped with the spray outlet assembly 21 and a rear end equipped with the switching handle 8.

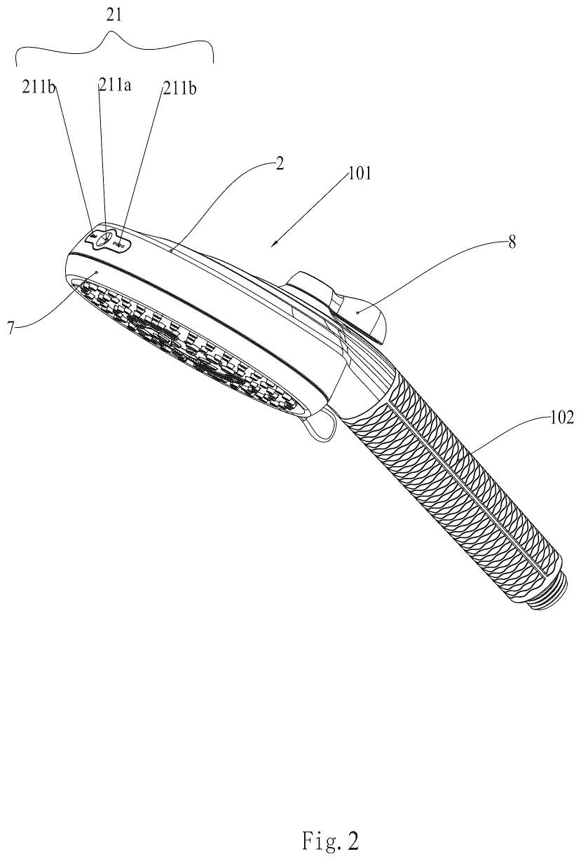

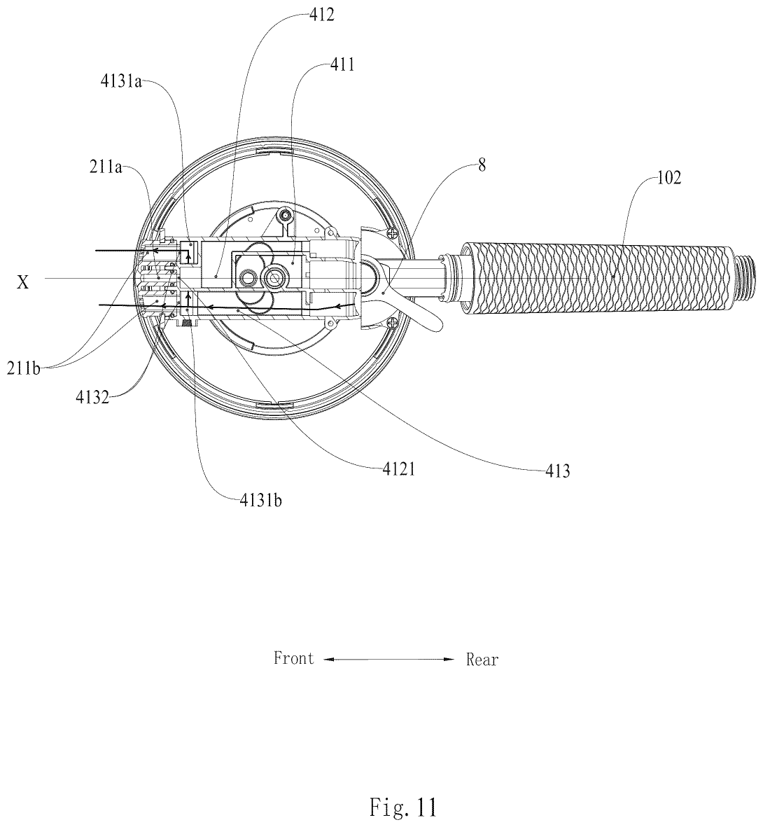

As shown in FIG. 2, the spray outlet assembly 21 includes a first spray nozzle 211a and a second spray nozzle 211b arranged side by side in a radial end of the showerhead housing 2. As shown in FIG. 1 and FIG. 11, the first spray nozzle 211a is a single spray nozzle hole, which is arranged at a front end of the showerhead housing 2 and passes through the median axis X of the showerhead housing 2, and is configured to generate a convergent sprayed water splash; the second spray nozzle 211b includes multiple spray nozzle holes which are arranged at two ends of the first spray nozzle 211a, and are configured to generate a scattering sprayed water splash. Of course, the spray outlet assembly 21 can retain only the first spray nozzle 211a or retain only the second spray nozzle 211b.

The shower outlet assembly 7 is configured with multiple different functional water splashes (such as massage water splashes, bubble water splashes, etc.), and each of the functional water splashes is correspondingly provided with a water inlet 72 in an water inlet end face 71 of the shower outlet assembly 7. The shower outlet assembly 7 is turnably arranged on the showerhead housing 2. Regarding how the shower outlet assembly 7 is configured with different functional water splashes, it is a prior art and will not be described in detail; of course, if the shower outlet assembly 7 is set to have a single function, the shower outlet assembly 7 can be fixedly installed on the showerhead housing 2.

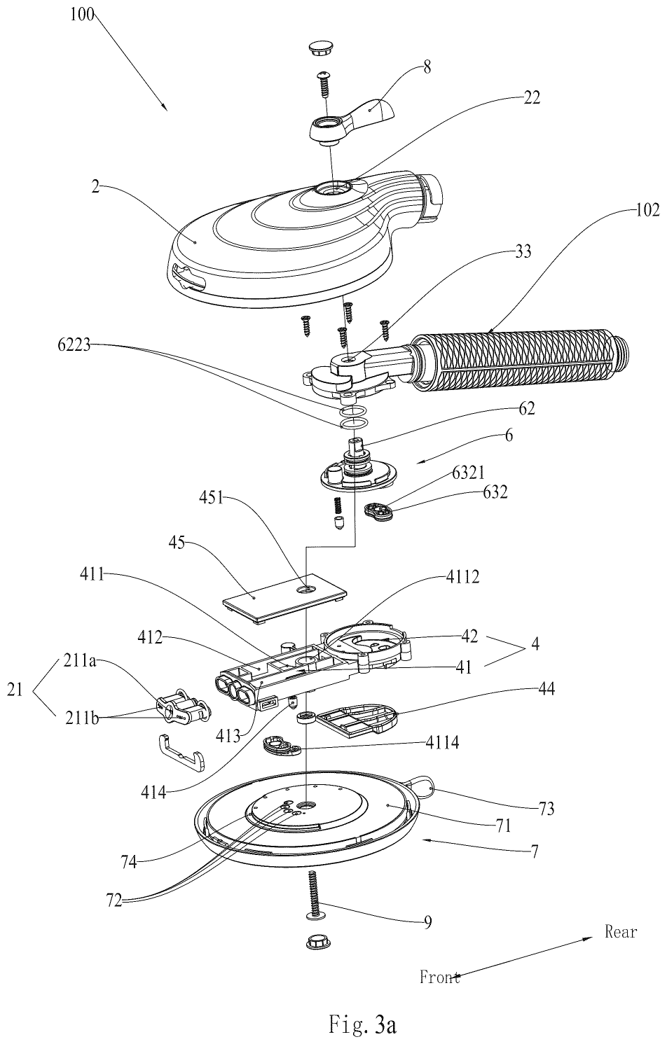

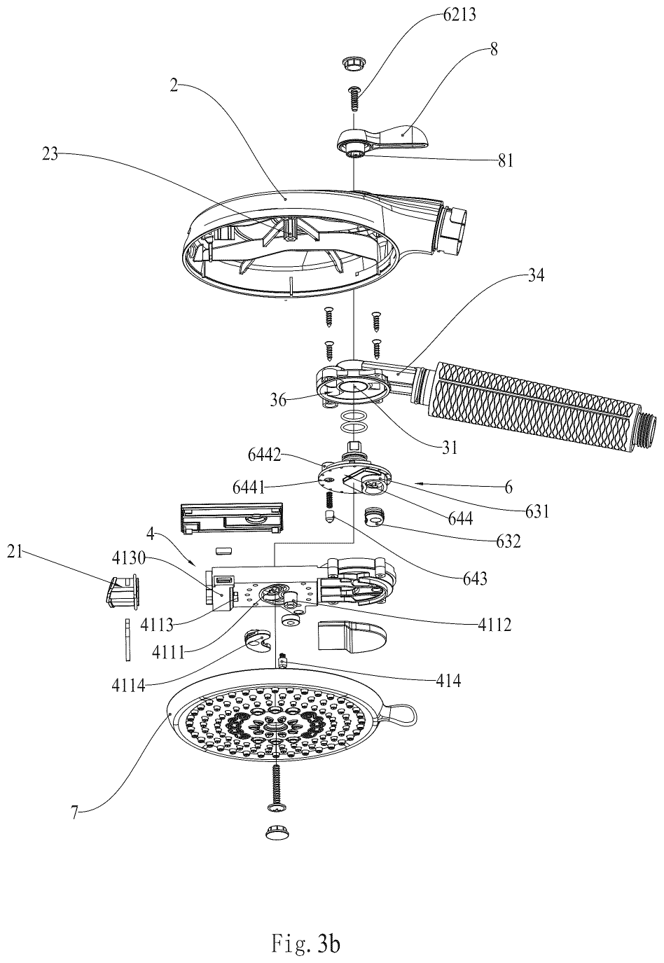

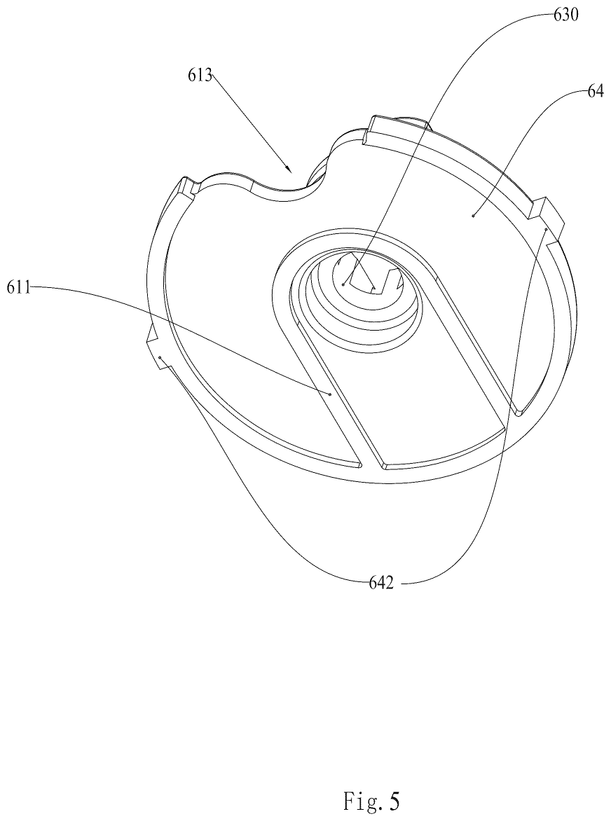

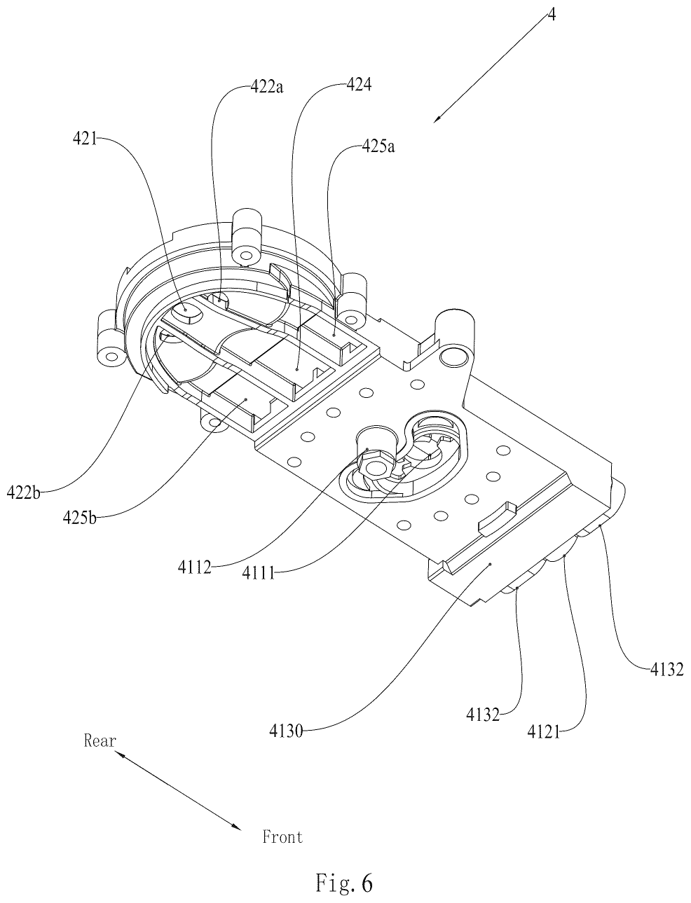

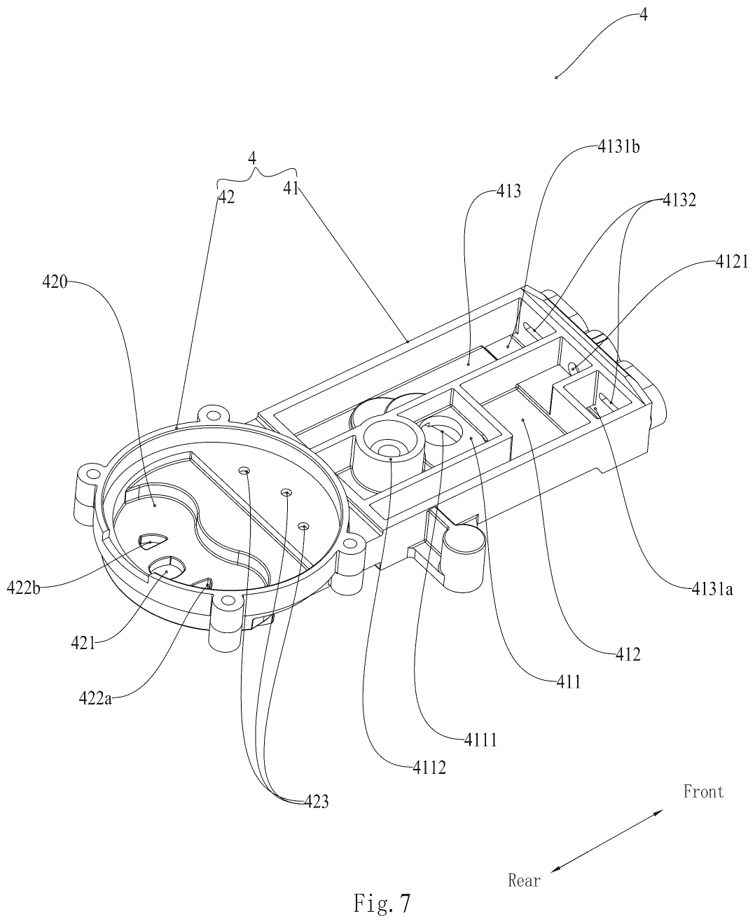

As shown in FIG. 2 and FIG. 3, the water distribution body 4 is arranged between the showerhead housing 2 and the shower outlet assembly 7, and the water distribution body 4 is composed of a water outlet tray 41 and a water distribution tray 42 arranged side by side in the front and back. As shown in FIG. 6 and FIG. 7, the water outlet tray 41 includes a flow passage 411, a first pressurizing chamber 412 and a second pressurizing chamber 413, the water paths of which are separated from each other. In this embodiment, the water outlet tray 41 is rectangular, the flow passage 411 is provided with a second water outlet 4111 opening downward, a sealing element 4114 is sleeved on a water outlet end face of the second water outlet 4111, and the sealing element 4114 has a through hole corresponding to the second water outlet 4111. The second water outlet 4111 of the flow passage 411 selectively comes into fluid communication with the water inlets 72 of the shower outlet assembly 7 for realizing water path switching. A second positioning sound device 414 is additionally provided between the water outlet tray 41 and the water inlet end face 71 of the shower outlet assembly 7 to determine the precise switching of the water inlets 72. In this embodiment, a paddle 73 is provided at an outer radial end of the shower outlet assembly 7, and the paddle 73 is driven by external force to drive each water inlet 72 of the shower outlet assembly 7 to come into fluid communication with the second water outlet 4111, so that the shower outlet assembly 7 can spray water splashes with different functions outward. Moreover, as shown in FIG. 2 and FIG. 3, a position-limiting block 4113 is provided on a bottom end face of the water outlet tray 41, and a position-limiting arc-shaped groove 74 is provided at a position, corresponding to the position-limiting block 4113, of the water inlet end face 71 of the water outlet assembly 7, the position-limiting block 4113 and the position-limiting arc-shaped groove 74 are engaged with each other, thereby realizing the limitation of the rotation angle range of the shower outlet assembly 7. It should be noted that the flow passage 411 may be designed as a chamber with a pressurization effect or a chamber without a pressurization effect or even with a negative pressure effect as required.

The first pressurizing chamber 412 is provided with a third water outlet 4121 facing forward horizontally on a side away from the water distribution tray 42, the third water outlet 4121 is configured to be in fluid communication with the first spray nozzle 211a. The second pressurizing chamber 413 is separated into two sub-water path channels 4131a and 4131b on the side away from the water distribution tray 42. In this embodiment, the water distribution tray 42 is in the shape of a tray, and includes a first water distribution port 421 and two second water distribution ports 422a, 422b. The bottoms of the first water distribution port 421 and the second water distribution ports 422a, 422b of the water distribution tray 42 respectively form a first water distribution channel 424 and two second water distribution channels 425a, 425b. An extension direction of the first water distribution channel 424 is arranged crosswise with the opening direction of the first water distribution port 421. The first water distribution channel 424 is in communication with the flow passage 411, and the flow passage 411 is in communication with each water inlet 72 of the shower outlet assembly 7. Water outlet ends of the two second water distribution ports 422a, 422b of the water distribution tray 42 respectively form two second water distribution channels 425a, 425b. Extension directions of the second water distribution channels 425a, 425b are respectively arranged crosswise with the opening directions of the corresponding second water distribution ports 422a and 422b, and the second water distribution channels 425a, 425b are respectively in communication with the corresponding first pressurizing chamber 412 and second pressurizing chamber 413. The cross arrangement disclosed in this embodiment is a substantially perpendicularly cross arrangement. Of course, ordinary technicians in this field can adaptively adjust the angle range between the extension direction of the water distribution channel and the opening direction of the water distribution port according to practical conditions, and it is not necessarily a perpendicularly cross arrangement. In this embodiment, the flow passage 411 of the water outlet tray 4 is further provided with an assembly cavity 4112 that is isolated from water flow and is through from top to bottom. The assembly cavity 4112 is configured for the insertion of a long bolt 9. Of course, the assembly cavity 4112 is not necessarily arranged at the flow passage 411, and may also be arranged in the first pressurizing chamber 412 or the second pressurizing chamber 413 according to the requirements of the assembly position.

As shown in FIG. 6 and FIG. 7, the first pressurizing chamber 412 and the second pressurizing chamber 413 are respectively configured to receive water flowing into the second water outlet 422a and the second water outlet 422b and pressurize it before the water is sprayed out from the spray nozzles. In this embodiment, the third water outlet 4121 of the first pressurizing chamber 412 is set in the middle position, and the third water outlet 4121 is fluidly connected to the first spray nozzle 211a. The second pressurizing chamber 413 uses a water cavity channel 4130 set at the front end to divide into two sub-water path channels 4131a, 4131b, and the two sub-water path channels 4131a, 4131b are each equipped with a fourth water outlet 4132 facing forward horizontally, and the fourth water outlets 4132 are respectively fluidly connected to the spray nozzle holes of the second spray nozzle 211b.

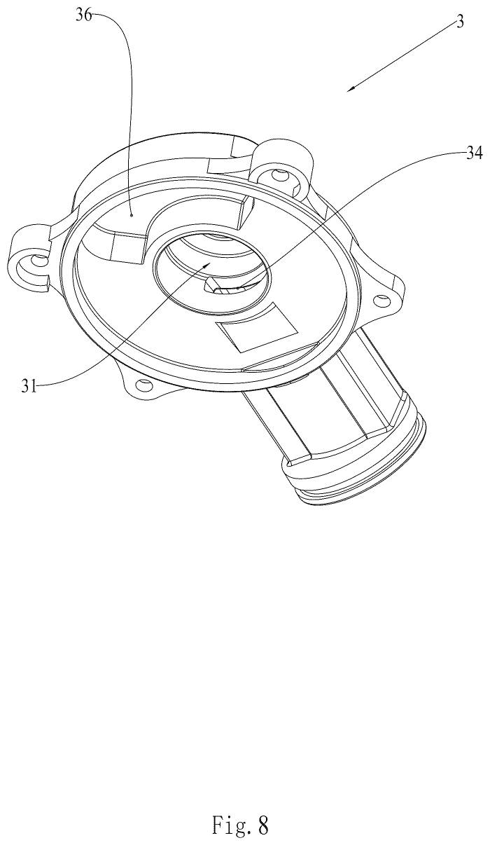

As shown in FIG. 8 and FIG. 2, the water inlet module 3 is arranged between the showerhead housing 2 and the water distribution tray 42, and the water inlet module 3 includes a water inlet cavity 31 with an opening facing downward and a first water inlet channel 34 via which the handle portion 102 is in fluid communication with the water inlet cavity 31. The water inlet module 3 is provided with an axially through-going assembly hole 33 in the axial direction of the water inlet cavity 31, and the showerhead housing 2 is provided with a through hole 22 in a position corresponding to the assembly hole 33.

As shown in FIG. 2 to FIG. 5, in this embodiment, the turning tray 6 includes a driven tray 61 and a turning tray cover 64, and is turnably arranged above the water distribution tray 42. A convex column 62 is arranged upwardly in a central portion of the driven tray 61, and a connector 621 is formed on an upper part of the convex column 62. A middle part of the convex column 62 is at least provided with a lateral water inlet 622 and a water channel 630 extending downward, and two sealing rings 6223 are sleeved on an upper part 6221 and a lower part 6222 of the lateral water inlet 622 of the convex column 62 respectively. A first water outlet 63 is eccentrically arranged in the turning tray cover 64, and a second water inlet channel 65 is formed between the lateral water inlet 622 and the first water outlet 63. A sealing element 632 is sleeved on a water outlet end of the first water outlet 63, and the sealing element 632 has a through hole 6321 corresponding to the first water outlet 63. A U-shaped convex edge 611 is provided at the bottom of the driven tray 61, and the convex edge 611 extends from the center to the radial end. The turning tray cover 64 is provided with a recess 641 at a position corresponding to the convex edge 611, and the first water outlet 63 is located in the recess 641 and at one side corresponding to the radial end. At least two positioning blocks 612 extending outward are formed at an outer radial end of the driven tray 61, a retaining edge 642 is formed by extending upward from a top end face of the turning tray cover 64 at its peripheral edge, at least positioning notches 6421 for clamping the positioning blocks 612 are provided at the retaining edge 642, and the mutual clamping between the positioning blocks 612 and the positioning notches 6421 is used to realize the pre-positioning between the driven tray 61 and the turning tray cover 64. The driven tray 61 and the turning tray cover 64 are fixedly connected to form the turning tray 6 by ultrasonic welding, and then the convex edge 611 of the driven tray 61 and the recess 641 of the turning tray cover 64 are positioned in a sealed manner to form a water flow cavity 66, and the water flow cavity 66 belongs to a part of the second water inlet channel 65.

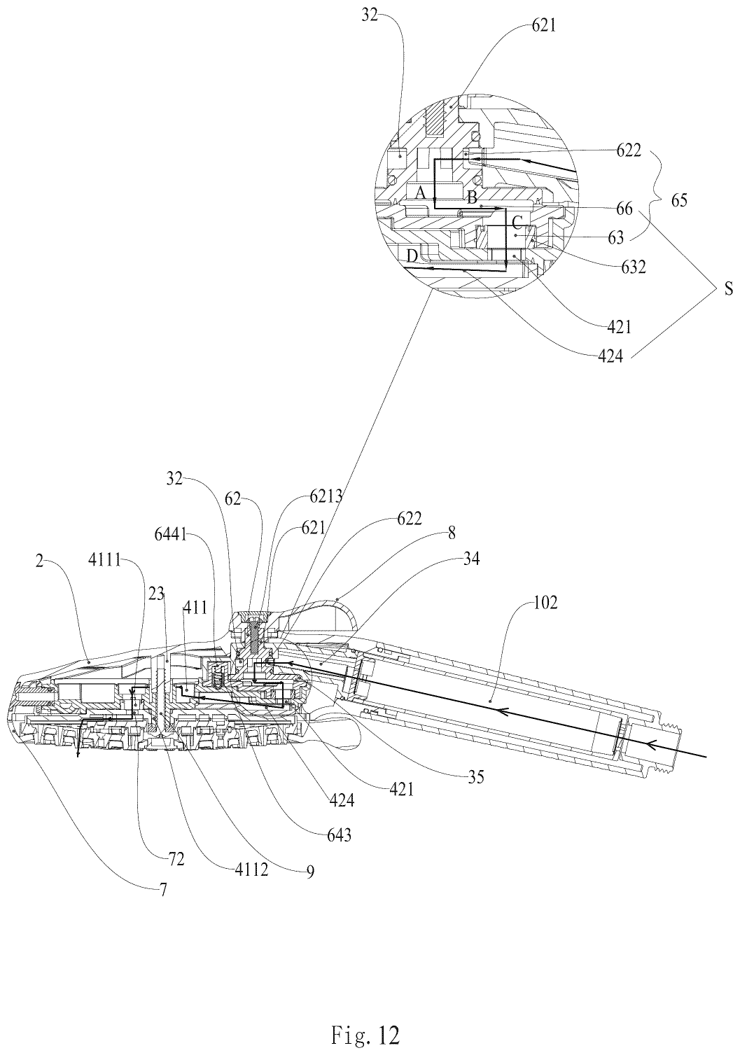

As shown in FIG. 12, the water inlet module 3 and the water distribution tray 42 are fixedly connected to each other and form an installation cavity 35, the turning tray 6 is disposed into the installation cavity 35, the convex column 62 is inserted into the water inlet cavity 31, and its connector 621 passes through the assembly hole 33 and the through hole 22 in sequence, and is locked with a switching handle 8 outside the showerhead housing 2. By means of the two sealing rings 6223 arranged on the convex column 62, the convex column 62 forms a separated chamber 32 in the water inlet cavity 31, and the water flowing out of the first water inlet channel 34 enters the separated chamber 32 and flows into the lateral water inlet of the second water inlet channel 65, thereby achieving the fluid communication between the first water inlet channel 34 and the second water inlet channel 65. The switching handle 8 is arranged on the head portion 101 and adjacent to the handle portion 102. The switching handle 8 is fixedly connected to the convex column 62 through the through hole 22. By driving the switching handle 8 to rotate, the first water outlet 63 of the turning tray 6 is driven to come into fluid communication with each of the first water distribution port 421 or any of the second water distribution ports 422a, 422b, so as to realize the water path switching of the first spray nozzle 211a, the second spray nozzle 211b in the spray outlet assembly 21 and the shower outlet assembly 7.

The water distribution tray 42 of the water distribution body 4 is further provided with a sunken water distribution recess 420, the first water distribution port 421 and the two second water distribution ports 422a and 422b are arranged in the water distribution recess 420. The first water outlet 63 of the turning tray 6 is arranged in a raised annular recess 631 (as shown in FIG. 3), the annular recess 631 is internally disposed in the water distribution recess 420, and two outer side walls of the annular recess 631 are respectively limited against two inner side walls of the water distribution recess 420, thereby limiting the range of the turning angle of the raining tray 6. Of course, if there is enough space, for example, the thickness of the turning tray 6 is consistent with the height of the annular recess 631, that is, the annular recess is not provided, and the water distribution recess 420 is a flat upper surface without sinking design, then the turning tray 6 can rotate 360 degrees relative to the water distribution tray 42. When the connector 621 of the convex column 62 is turned under force, the first water outlet 63 of the turning tray 6 moves in the water distribution recess 420 to switch to fluidly communicate with the first water distribution port 421 or the second water distribution ports 422a, 422b to ensure the positioning and sealing effect of the switching process. A first positioning sound device 643 configured to determine the turning angle of the turning tray cover 64 is additionally provided between the turning tray cover 64 and the water distribution tray 42 to further ensure the accurate positioning of the above switching.

The outer contour of the connector 621 is designed to be non-circular, and it has a turning axis 6211, and a threaded hole 6212 is provided along the turning axis 6211. The switching handle 8 has an assembly cavity 81 extending towards the connector 621, and the inner contour of the assembly cavity 81 matches the outer contour of the connector 621. The connector 621 is inserted into the assembly cavity 81, and a screw 6213 passes through the assembly cavity 81 of the switching handle 8 to be locked in the threaded hole 6212 of the connector 621, thereby realizing the locking of the connector 621 with respect to the switching handle 8.

As shown in FIG. 2, in this embodiment, the lower end face 644 of the turning tray cover 64 is provided with a downwardly opening accommodating cavity 6441, and the accommodating cavity 6441 is formed by a cylindrical shell 6442 extending upward. The first positioning sound device 643 is designed as an elastic button 643, and the elastic button 643 is elastically arranged in the accommodating cavity 6441.

The water distribution tray 42 of the water distribution body 4 is correspondingly provided with at least two positioning holes 423. In this embodiment, three positioning holes 423 are provided, corresponding to the one first water distribution port 421 and the two second water distribution ports 422a, 422b respectively. When the connector 621 is rotated under force, and the first water outlet 63 comes into communication with the first water distribution port 421 or the two second water distribution ports 422a, 422b respectively, the elastic button 643 is elastically engaged into different positioning holes 423 respectively, so as to realize the precise positioning of the first water distribution port 421 or the second water distribution ports 422a, 422b.

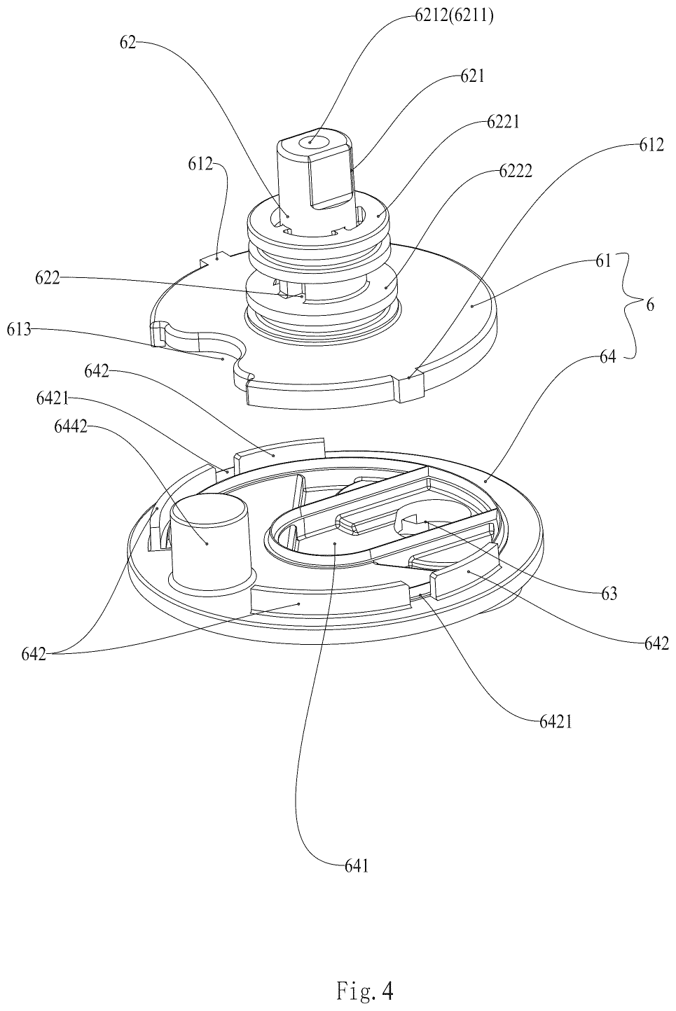

As shown in FIG. 8 combined with FIG. 3 and FIG. 4, a clearance arc-shaped recess 36 is provided beside the water inlet cavity 31 of the water inlet module 3. As the turning tray 6 rotates and switches and the elastic button 643 is engaged into different positioning holes 423, the cylindrical shell 6442 of the accommodating cavity 6441 moves in the clearance arc-shaped recess 36. In this embodiment, the driven tray 61 is also provided with a clearance notch 613, so that the accommodating cavity 6441 of the turning tray cover 64 can directly extend into the clearance gap 613 without being interfered by the driven tray 61.

As shown in FIG. 2 and FIG. 3, a bottom cover 44 is provided below the water distribution tray 42 of the water distribution body 4, and an upper cover 45 is provided above the water outlet tray 41. Through the above separated design, the water distribution body 4 with the relatively complex structure is easy to be injection molded. The upper cover 45 is further provided with a through hole 451 corresponding to the assembly cavity 4112. As shown in the figure, a long bolt 9 passes through the through hole 22 in a central portion of the water outlet cover, passes through the assembly cavity 4112 and the through hole 451 of the upper cover 45, and then is locked with the built-in threaded column 23 at the showerhead housing 2, so as to achieve a tight assembly of the entire handshower.

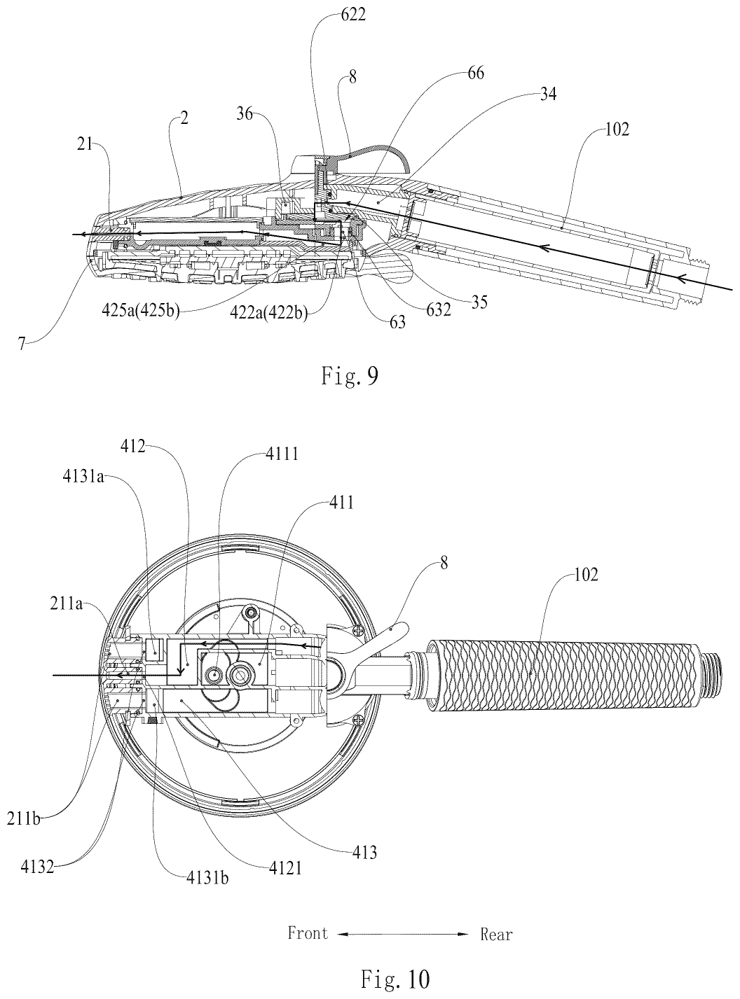

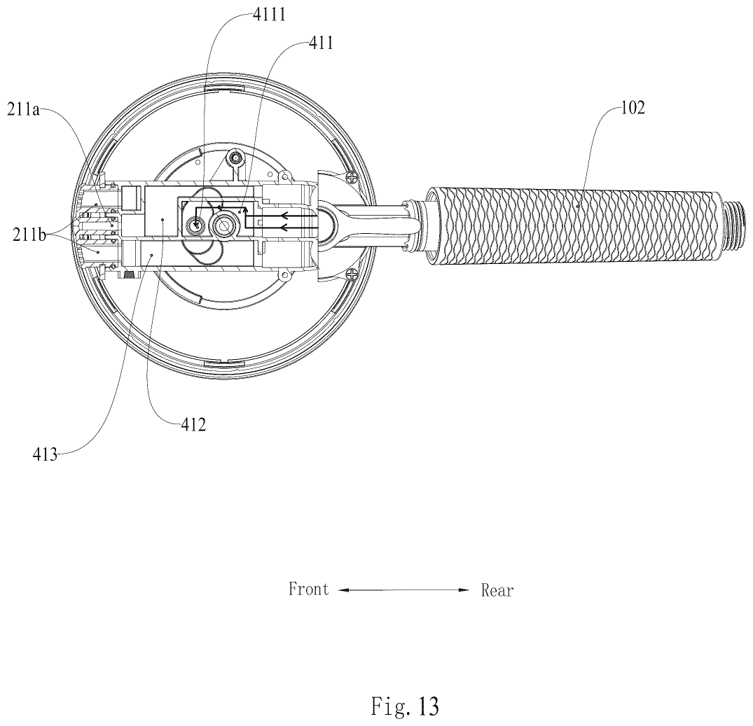

The following is a detailed description of the working principle of the water path switching of the handshower disclosed in the present invention. As shown in FIG. 12 to FIG. 13, the switching handle 8 is placed at a position passing through the central axis X of the showerhead housing 2, water flows in from the handle portion 102, flows into the water inlet cavity 31 of the water inlet module 3 through the first water inlet channel 34, and flows in through the lateral water inlet 622 of the convex column 62 of the turning tray 6, flows out from the first water outlet 63 and flows into the first water distribution port 421 of the water distribution tray 42, flows out from the second water outlet 4111 through the flow passage 411 and flows into each water inlet 72 in the water inlet end face 71 of the shower outlet assembly 7, thereby realizing the water path switching between the various functional water of the shower outlet assembly 7. As shown in FIG. 10 combined with FIG. 9, when the switching handle 8 is turned counterclockwise, the water flow trace from the handle portion 102 to the first water outlet 63 is consistent with the former, and will not be described in detail, water flows out from the first water outlet 63 and flows into the second water distribution port 422a of the water distribution tray 42, and is ejected out from the first spray nozzle 211a through the third water outlet 4121 of the first pressurizing chamber 412. As shown in FIG. 11 combined with FIG. 9, when the switching handle 8 is turned clockwise, water flows out from the first water outlet 63 and flows into the second water distribution port 422b of the water distribution tray 42, and is ejected out from the second spray nozzle 211b through the two fourth water outlets 4132 of the second pressurizing chamber 412.

With the above arrangement, taking the water discharge of the shower outlet assembly 7 as an example, as shown in FIG. 12, the water flowing in from the handle portion 102 flows in through the lateral water inlet 622 of the turning tray 6, flows in a first direction A to a water inlet end of the water flow cavity 66, flows in a second direction B to a water outlet end of the water flow cavity 66, flows in a third direction C in sequence into the first water outlet 63 and the first water distribution port 421, and then flows in a fourth direction D in sequence into the first water distribution channel 424 and the flow passage 411, and flows out from the second water outlet 4111. The first direction A is substantially parallel to the third direction C, and the flow directions are consistent. The second direction B is substantially parallel to the fourth direction D, but the flow directions are opposite. Moreover, the first direction A and the second direction B are arranged perpendicularly. With the above structure, the turning tray 6 forms the second water inlet channel 65 arranged with three 90-degree turning angles between the lateral water inlet 622 and the first water outlet 63. Of course, if the water inlet end of the turning tray 6 is not arranged at the lateral side but at a position parallel to the first direction A, the second water inlet channel (not shown) arranged with two 90-degree turning angles is formed between the water inlet and the first water outlet 63. Obviously, the former second water inlet channel 65 arranged with three 90-degree angles is a more preferred solution. Compared with the latter second water inlet channel arranged with two 90-degree turning angles, the former solution will further reduce the flow rate of water in the second water inlet channel 65. Moreover, since the first water distribution channel 424 extending in the fourth direction D is further provided at the bottom of the first water distribution port 421, a water storage chamber S with a relatively low water flow rate can be formed in the space from the water flow cavity 66 of the turning tray 6 to the first water distribution channel 424. The water accumulated in the water storage chamber S can exert a pressure toward the water distribution tray 42 on the sealing element 632 according to its flow direction, and may also reduce the back pressure formed at the first water outlet 63 of the turning tray 6. The above two factors drive the sealing element 632 to be more closely attached to the water inlet end face of the water distribution tray 42, so that the turning tray 6 does not need to be closely attached to the water inlet end face of the water distribution tray 42 when the showerhead 100 is set at the factory, and the rotating plate 6 can be relatively easily turned relative to the water distribution tray 43. Moreover, because the rotation axis of the turning tray 6 is connected to a fixed end of the switching handle 8, its force application point is located at a free end of the switching handle 8, thus when the finger acts on the free end of the switching handle 8, the force applied to the switching handle 8 can be further reduced by virtue of the effect of amplifying by the force arm, so that the switching hand feel is lighter and the shower experience is improved.

The above description merely relates to embodiments of the present disclosure, and is not intended to limit the design of the present disclosure. Any equivalent changes made according to key points of the design of the present disclosure will fall within the scope of protection of the present disclosure.

1. A handshower with a sprayer function, comprising a head portion and a handle portion, wherein the head portion comprises a showerhead housing, a water distribution body, a turning tray, a spray outlet assembly, a shower outlet assembly and a switching handle;
the showerhead housing has a hollow inner cavity, and has a front end equipped with the spray outlet assembly and a rear end equipped with the switching handle, the spray outlet assembly comprises at least one spray nozzle, each of the at least one spray nozzle corresponds to a spray mode, and the shower outlet assembly is installed on the showerhead housing;
the water distribution body is arranged between the showerhead housing and the shower outlet assembly, and the water distribution body is composed of a water outlet tray and a water distribution tray arranged side by side in the front and back respectively, the water outlet tray comprises one flow passage and at least one pressurizing chamber, a water path of each of the at least one pressurizing chamber and a water path of the flow passage are separated from each other;
the water distribution tray comprises one first water distribution port and at least one second water distribution port, a number of the at least one pressurizing chamber and a number of the at least one second water distribution port are each consistent with a number of the at least one spray nozzle; a water outlet end of the first water distribution port of the water distribution tray forms one first water distribution channel, and an extension direction of the first water distribution channel is arranged crosswise with an opening direction of the first water distribution port, the first water distribution channel is in communication with the flow passage, and the flow passage is in communication with the shower outlet assembly; and a water outlet end of the at least one second water distribution port of the water distribution tray respectively form corresponding number of at least one second water distribution channel, an extension direction of each of the at least one second water distribution channel is arranged crosswise with an opening direction of the corresponding second water distribution port, each of the at least one second water distribution channel is in communication with the corresponding pressurizing chamber, and the pressurizing chamber is configured to pressurize the water flowing in and then come into communication with the corresponding spray nozzle;
the turning tray is turnably provided on the water distribution tray, a bottom end face of the turning tray is provided with a first water outlet in fluid communication with the handle portion, a sealing element is sleeved on the first water outlet, the sealing element is provided with a through hole corresponding to the first water outlet, a connecting member is provided at a central portion of the turning tray, and the showerhead housing is provided with a through hole at a position corresponding to the connecting member, the switching handle is fixedly connected to the connecting member through the through hole; and
when the switching handle is driven to turn, to further drive the first water outlet of the turning tray to come into fluid communication with the first water distribution port or one of the at least one second water distribution port, and in this way, water path switching of the spray outlet assembly and the shower outlet assembly is achieved.

2. The handshower with a sprayer function according to claim 1, wherein the switching handle is equipped on the head portion and adjacent to the handle portion.

3. The handshower with a sprayer function according to claim 1, wherein a water inlet module is provided between the showerhead housing and the water distribution tray, and the water inlet module comprises a water inlet cavity with an opening facing downward and a first water inlet channel via which the handle portion is in fluid communication with the water inlet cavity; the water inlet module is provided with an assembly hole in an axial direction of the water inlet cavity, and a position of the assembly hole corresponds to a position of the through hole of the showerhead housing; and
the connecting member of the turning tray is configured as a convex column protruding upward, a connector is formed on an upper part of the convex column, a middle part of the convex column is at least provided with a lateral water inlet, and two sealing rings are sleeved on an upper part and a lower part of the lateral water inlet of the convex column respectively, the first water outlet of the turning tray is eccentrically arranged in a bottom end face of the turning tray, and a second water inlet channel is formed between the lateral water inlet and the first water outlet; and the water inlet module and the water distribution tray are fixedly connected to each other and form an installation cavity, the turning tray is disposed into the installation cavity, the convex column is inserted into the water inlet cavity, and its connector passes through the assembly hole and the through hole in sequence, and is locked with the switching handle outside the showerhead housing, by means of the two sealing rings arranged on the convex column, the convex column forms a separated chamber in the water inlet cavity, and the water flowing out of the first water inlet channel enters the separated chamber and flows into the lateral water inlet of the second water inlet channel, and in this way, the fluid communication between the first water inlet channel and the second water inlet channel is achieved.

4. The handshower with a sprayer function according to claim 3, wherein the turning tray comprises a driven tray and a turning tray cover; the convex column is arranged on the driven tray, a U-shaped convex edge is provided at a bottom of the driven tray, and the U-shaped convex edge extends from the center to a radial end; the turning tray cover is provided with a recess at a position corresponding to the convex edge, and the first water outlet is located in the recess and at one side corresponding to the radial end; and the driven tray is fixedly connected to the turning tray by ultrasonic welding.

5. The handshower with a sprayer function according to claim 4, wherein at least two positioning blocks extending outward are formed at an outer radial end of the driven tray, a retaining edge is formed by extending upward from a top end face of the turning tray cover at its peripheral edge, at least positioning notches for clamping the positioning blocks are provided at the retaining edge, and the mutual clamping between the positioning blocks and the positioning notches is used to realize a pre-positioning between the driven tray and the turning tray cover.

6. The handshower with a sprayer function according to claim 4, wherein a first positioning sound device configured to indicate a turning angle of the turning tray cover is additionally provided between the turning tray cover and the water distribution tray.

7. The handshower with a sprayer function according to claim 3, wherein an outer contour of the connector is designed to be non-circular and has a turning axis, and a threaded hole is provided along the turning axis, the switching handle has an assembly cavity extending towards the connector, and an inner contour of the assembly cavity matches the outer contour of the connector, the connector is inserted into the assembly cavity, and a screw passes through the assembly cavity of the switching handle to be locked in the threaded hole of the connector, and in this way, the locking of the connector with respect to the switching handle is realized.

8. The handshower with a sprayer function according to claim 1, wherein the shower outlet assembly is configured with a plurality of different functional water splashes, and each of the plurality of functional water splashes is correspondingly provided with a water inlet in an water inlet end face of the shower outlet assembly; and the flow passage is provided with a second water outlet opening downward; a second positioning sound device is additionally provided between the water outlet tray and the water inlet end face of the shower outlet assembly to indicate a turning angle of the water outlet tray; by the shower outlet assembly being turnably arranged on the showerhead housing, the second water outlet of the flow passage selectively comes into fluid communication with the water inlets in the water inlet end face of the shower outlet assembly to realize functional water switching of the shower outlet assembly.

9. The handshower with a sprayer function according to claim 3, wherein the shower outlet assembly is configured with a plurality of different functional water splashes, and each of the plurality of functional water splashes is correspondingly provided with a water inlet in an water inlet end face of the shower outlet assembly; and the flow passage is provided with a second water outlet opening downward; a second positioning sound device is additionally provided between the water outlet tray and the water inlet end face of the shower outlet assembly to indicate a turning angle of the water outlet tray; by the shower outlet assembly being turnably arranged on the showerhead housing, the second water outlet of the flow passage selectively comes into fluid communication with the water inlets in the water inlet end face of the shower outlet assembly to realize functional water switching of the shower outlet assembly.

10. The handshower with a sprayer function according to claims 1, wherein the spray outlet assembly comprises a first spray nozzle and a second spray nozzle, the first spray nozzle is a single spray nozzle hole arranged at a front end of the showerhead housing, passing through a median axis X of the showerhead housing and configured to generate a convergent sprayed water splash, the second spray nozzle comprises a plurality of spray nozzle holes arranged at two ends of the first spray nozzle and configured to generate a scattering sprayed water splash; the water outlet tray of the water distribution body is in a rectangular shape, has a first pressurizing chamber and a second pressurizing chamber with separated water paths, the first pressurizing chamber is configured to be in fluid communication with the first spray nozzle, and the second pressurizing chamber is separated into two sub-water path channels configured to be in fluid communication with the plurality of spray nozzle holes of the first spray nozzle respectively, the water distribution tray comprises two second water distribution ports, one of the two second water distribution ports is configured to be in communication with the first pressurizing chamber, and the other of the two second water distribution ports is configured to be in communication with the second pressurizing chamber, the first water outlet of the turning tray selectively comes into fluid communication with one of the second water distribution ports to realize water path switching between the first spray nozzle and the second spray nozzle.

11. The handshower with a sprayer function according to claims 3, wherein the spray outlet assembly comprises a first spray nozzle and a second spray nozzle, the first spray nozzle is a single spray nozzle hole arranged at a front end of the showerhead housing, passing through a median axis X of the showerhead housing and configured to generate a convergent sprayed water splash, the second spray nozzle comprises a plurality of spray nozzle holes arranged at two ends of the first spray nozzle and configured to generate a scattering sprayed water splash; the water outlet tray of the water distribution body is in a rectangular shape, has a first pressurizing chamber and a second pressurizing chamber with separated water paths, the first pressurizing chamber is configured to be in fluid communication with the first spray nozzle, and the second pressurizing chamber is separated into two sub-water path channels configured to be in fluid communication with the plurality of spray nozzle holes of the first spray nozzle respectively, the water distribution tray comprises two second water distribution ports, one of the two second water distribution ports is configured to be in communication with the first pressurizing chamber, and the other of the two second water distribution ports is configured to be in communication with the second pressurizing chamber, the first water outlet of the turning tray selectively comes into fluid communication with one of the second water distribution ports to realize water path switching between the first spray nozzle and the second spray nozzle.

12. The handshower with a sprayer function according to claims 8, wherein the spray outlet assembly comprises a first spray nozzle and a second spray nozzle, the first spray nozzle is a single spray nozzle hole arranged at a front end of the showerhead housing, passing through a median axis X of the showerhead housing and configured to generate a convergent sprayed water splash, the second spray nozzle comprises a plurality of spray nozzle holes arranged at two ends of the first spray nozzle and configured to generate a scattering sprayed water splash; the water outlet tray of the water distribution body is in a rectangular shape, has a first pressurizing chamber and a second pressurizing chamber with separated water paths, the first pressurizing chamber is configured to be in fluid communication with the first spray nozzle, and the second pressurizing chamber is separated into two sub-water path channels configured to be in fluid communication with the plurality of spray nozzle holes of the first spray nozzle respectively, the water distribution tray comprises two second water distribution ports, one of the two second water distribution ports is configured to be in communication with the first pressurizing chamber, and the other of the two second water distribution ports is configured to be in communication with the second pressurizing chamber, the first water outlet of the turning tray selectively comes into fluid communication with one of the second water distribution ports to realize water path switching between the first spray nozzle and the second spray nozzle.

13. The handshower with a sprayer function according to claims 9, wherein the spray outlet assembly comprises a first spray nozzle and a second spray nozzle, the first spray nozzle is a single spray nozzle hole arranged at a front end of the showerhead housing, passing through a median axis X of the showerhead housing and configured to generate a convergent sprayed water splash, the second spray nozzle comprises a plurality of spray nozzle holes arranged at two ends of the first spray nozzle and configured to generate a scattering sprayed water splash; the water outlet tray of the water distribution body is in a rectangular shape, has a first pressurizing chamber and a second pressurizing chamber with separated water paths, the first pressurizing chamber is configured to be in fluid communication with the first spray nozzle, and the second pressurizing chamber is separated into two sub-water path channels configured to be in fluid communication with the plurality of spray nozzle holes of the first spray nozzle respectively, the water distribution tray comprises two second water distribution ports, one of the two second water distribution ports is configured to be in communication with the first pressurizing chamber, and the other of the two second water distribution ports is configured to be in communication with the second pressurizing chamber, the first water outlet of the turning tray selectively comes into fluid communication with one of the second water distribution ports to realize water path switching between the first spray nozzle and the second spray nozzle.
